(19) United States
(12) Patent Application Publication
(10) Pub. No.: US 2022/0325118 A1
(43) Pub. Date: Oct. 13, 2022

(54) Colorant Dispersion And Ink Composition For Aqueous Ink Jet Recording

(71) Applicant: Seiko Epson Corporation, Tokyo (JP)

(72) Inventor: Nikako TSUKIJI, Matsumoto (JP)

(21) Appl. No.: 17/711,107

(22) Filed: Apr. 1, 2022

(30) Foreign Application Priority Data
Apr. 2, 2021 (JP) 2021-063322

(51) Int. Cl. C09D 11/033; C09D 11/104; C09D 11/40; C09D 11/328

(52) U.S. Cl. CPC C09D 11/033; C09D 11/104; C09D 11/40; C09D 11/328

(57) ABSTRACT

A colorant dispersion contains water, (meth)acrylic resin particles containing a disperse dye, a nonionic surfactant, and a tertiary amine compound represented by Formula (1) below:

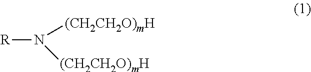

where R represents —(CH₂CH₂O)ₘH, an aliphatic group containing 6 to 18 carbon atoms, or an aromatic group and each m independently represents an integer of 1 to 10. The (meth)acrylic resin particles have a glass transition temperature of 60° C. or higher and contain 10% by mass or more of the disperse dye with respect to the total mass of the (meth)acrylic resin particles.

The present application is based on, and claims priority from JP Application Serial Number 2021-063322, filed Apr. 2, 2021, the disclosure of which is hereby incorporated by reference herein in its entirety.

### BACKGROUND

### 1. Technical Field

The present disclosure relates to a colorant dispersion and an ink composition for aqueous ink jet recording.

### 2. Related Art

Aqueous inks are becoming the mainstream of ink jet recording inks in response to requirements such as environmental friendliness. Water-soluble dye inks made by dissolving a water-soluble dye in water are widely known; have advantages that the number of colors is large, the tone of colors is clear, and prints having excellent image quality can be readily obtained; and have disadvantages such as poor bleeding resistance, poor water resistance, and poor light resistance. Aqueous inks made by dispersing pigment in an aqueous medium are good in water resistance and light resistance, have a smaller number of colors as compared to dyes, and generally tend to be poor in color clarity and transparency. In techniques in the related art, the type of recording media is limited due to colorants of these aqueous inks.

In order to solve these problems, a large number of aqueous inks containing colored resin microparticles have been proposed. For example, JP-A-9-279073 discloses colored resin microparticles obtained by the emulsion polymerization of an anionic and/or nonionic reactive surfactant in an aqueous medium in the presence of a polymerizable unsaturated monomer and a coloring agent having affinity thereto.

However, the colored resin microparticles disclosed in JP-A-9-279073 have a problem that it is difficult to enhance dispersion stability. In reactive surfactants, there is a possibility that the dispersion stability of colored microparticles decrease during long-term storage. There is a problem in that it is difficult to enhance coloring properties of a recorded material obtained using the colored microparticles. When the colored microparticles are used in an ink composition for aqueous ink jet recording, there is a possibility that coloring properties of a recorded material are insufficient due to restrictions on the affinity between the polymerizable unsaturated monomer and the coloring agent. That is, a colorant dispersion excellent in coloring properties of a recorded material and storage stability is required.

### SUMMARY

According to an aspect of the present disclosure, a colorant dispersion contains water, (meth)acrylic resin particles containing a disperse dye, a nonionic surfactant, and a tertiary amine compound represented by Formula (1) below:

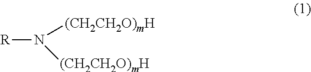

where R represents —(CH₂CH₂O)ₘH, an aliphatic group containing 6 to 18 carbon atoms, or an aromatic group and each m independently represents an integer of 1 to 10. The (meth)acrylic resin particles have a glass transition temperature of 60° C. or higher and contain 10% by mass or more of the disperse dye with respect to the total mass of the (meth)acrylic resin particles.

According to an aspect of the present disclosure, an ink composition for aqueous ink jet recording contains water, (meth)acrylic resin particles containing a disperse dye, a nonionic surfactant, and a tertiary amine compound represented by Formula (1) above. The (meth)acrylic resin particles have a glass transition temperature of 60° C. or higher and contain 10% by mass or more of the disperse dye with respect to the total mass of the (meth)acrylic resin particles.

### DESCRIPTION OF EXEMPLARY EMBODIMENTS

### Colorant Dispersion

A colorant dispersion according to an embodiment contains water, (meth)acrylic resin particles containing a disperse dye, a nonionic surfactant, and a tertiary amine compound represented by Formula (1) below:

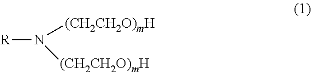

where R represents —(CH₂CH₂O)ₘH, an aliphatic group containing 6 to 18 carbon atoms, or an aromatic group and each m independently represents an integer of 1 to 10. Various components contained in the colorant dispersion are described below.

### Water

Water is a main solvent of the colorant dispersion according to this embodiment. After the colorant dispersion is applied to a recording medium such as paper, water is evaporated from the recording medium by drying. For example, pure water products such as ion-exchanged water, ultra-filtered water, reverse osmosis-filtered water, and distilled water and those, such as ultra-pure water, obtained by removing as much ionic impurities as possible can be used as water. Using water sterilized by ultraviolet irradiation, the addition of hydrogen peroxide, or the like enables the growth of fungi and bacteria to be prevented in the case of long-term storage.

The content of water contained in the colorant dispersion is not particularly limited, is preferably 40% by mass to 80% by mass, is more preferably 45% by mass to 75% by mass, and is further more preferably 50% by mass to 70% by mass with respect to the total mass of the colorant dispersion.

This enables the long-term storage stability of the colorant dispersion to be further enhanced and ensures the concentration of solid matter to enhance the ease of preparing an ink composition for aqueous ink jet recording.

### Disperse Dye

The disperse dye is generally insoluble or poorly soluble in water and therefore is a colorant that is usually dispersed in a dispersion medium with a dispersant. In the present specification, the term “insoluble in water” means that the solubility in water is 100 mg/liter or less at 25° C. and the term “poorly soluble in water” means that the solubility in water is more than 100 mg/liter to 1 g/liter. Since the disperse dye is contained in the (meth)acrylic resin particles, the colorant dispersion can be satisfactorily used for recording media such as fabrics including hydrophobic fiber fabrics, resin, plastic films, paper, glass, metal, and ceramics.

The disperse dye used may be a sublimation dye having a property of sublimating upon heating. Among various colorants, the sublimation dye is excellent in that a clear hue is obtained and is excellent in dyeing characteristics such as dyeing reproducibility, fastness, and bleeding resistance for recording media.

Examples of the disperse dye include, but are not limited to, C. I. (Colour Index Generic Name) Disperse Blues 3, 7, 9, 14, 16, 19, 20, 26, 26:1, 27, 35, 43, 44, 54, 55, 56, 58, 60, 62, 64, 64:1, 71, 72, 72:1, 73, 75, 79, 81, 81:1, 82, 83, 87, 91, 93, 94, 95, 96, 102, 106, 108, 112, 113, 115, 118, 120, 122, 125, 128, 130, 131, 139, 141, 142, 143, 145, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, and 333; C. I. Disperse Reds 1, 4, 5, 7, 11, 12, 13, 15, 17, 27, 43, 44, 50, 52, 53, 54, 55, 55:1, 56, 58, 59, 60, 65, 70, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 158, 190, 190:1, 207, 151, 152, 153, 154, 157, 159, 164, 167, 169, 177, 179, 181, 183, 184, 185, 188, 189, 191, 192, 200, 201, 202, 203, 205, 206, 210, 221, 224, 225, 227, 229, 239, 240, 257, 258, 277, 278, 279, 281, 288, 298, 302, 303, 310, 311, 312, 320, 324, and 328; C. I. Disperse Yellows 3, 4, 5, 7, 8, 9, 13, 23, 24, 30, 33, 34, 39, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, and 232; C. I. Disperse Blacks 1, 3, 10, and 24; C. I. Disperse Oranges 1, 1:1, 3, 5, 7, 11, 13, 17, 20, 21, 25, 25:1, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142; C. I. Disperse Violets 1, 4, 26, 31, 33, 35, 38, 40, 43, 46, 48, 50, 51, 52, 56, 59, 61, 63, 69, and 77; C. I. Disperse Green 9; C. I. Disperse Browns 1, 2, 4, 9, 13, and 19; C. I. Solvent Yellows 2, 14, 16, 21, 33, 43, 44, 56, 82, 85, 93, 98, 114, 131, 135, 157, 160, 163, 167, 176, 179, 185, and 189; C. I. Solvent Reds 8, 23, 24, 25, 49, 52, 109, 111, 119, 122, 124, 135, 146, 149, 150, 168, 169, 172, 179, 195, 196, 197, 207, 222, 227, 312, and 313; C. I. Solvent Blues 3, 4, 5, 35, 36, 38, 45, 59, 63, 67, 68, 70, 78, 83, 97, 101, 102, 104, 105, 111, and 122; C. I. Solvent Oranges 3, 14, 54, 60, 62, 63, 67, 86, and 107; C. I. Solvent Violets 8, 9, 11, 13, 14, 17, 23, 26, 27, 28, 29, 31, 36, 57, and 59; C. I. Solvent Greens 3, 5, 7, and 28; C. I. Solvent Brown 53; and C. I. Solvent Blacks 3, 5, 7, 27, 29, and 34.

The above-cited disperse dyes may be used alone or in combination as a colorant.

The content of the disperse dye is preferably 10% by mass to 55% by mass, more preferably 12% by mass to 50% by mass, and further more preferably 15% by mass to 45% by mass with respect to the total mass of the (meth)acrylic resin particles. When the content of the disperse dye is within the above range, coloring upon applying ink to a recording medium can be ensured and the gelation (increase in viscosity) of the colorant dispersion can be inhibited.

### (Meth)acrylic Resin Particles

A (meth)acrylic resin is not particularly limited as long as the (meth)acrylic resin is resin which contains constitutional units derived from (meth)acrylic acid, a (meth)acrylic acid ester, or a monomer having a (meth)acryloyl group. The (meth)acrylic resin may be a homopolymer or a copolymer. Examples of a monomer forming the (meth)acrylic resin include hydrophilic unit-forming monomers including carboxy group-bearing monomers such as (meth)acrylic acid, itaconic acid, maleic acid, and fumaric acid; sulfo group-bearing monomers such as styrenesulfonic acid; phospho group-bearing monomers such as 2-phosphoethyl (meth)acrylate; monomers such as anhydrides and salts of these acidic monomers; and hydroxy group-bearing monomers such as 2-hydroxyethyl (meth)acrylate and 3-hydroxypropyl (meth)acrylate and hydrophobic unit-forming monomers including aromatic ring-bearing monomers such as styrene, α-methyl styrene, and benzyl (meth)acrylate and aliphatic group-bearing monomers such as ethyl (meth)acrylate, methyl (meth)acrylate, (iso)propyl (meth)acrylate, (n-, iso-, t-)butyl (meth)acrylate, and 2-ethylhexyl (meth)acrylate. An acrylic resin preferably has a hydrophilic unit derived from an anionic monomer. Examples of a cation forming a salt of the anionic monomer include ions of lithium, sodium, potassium, ammonium, organic ammonium, and the like.

In the present specification, the term “(meth)acryloyl” refers to at least either of acryloyl and methacryloyl corresponding thereto, the term “(meth)acrylate” refers to at least either of acrylate and methacrylate corresponding thereto, and the term “(meth)acrylic” refers to at least either of acrylic and methacrylic corresponding thereto.

The glass transition temperature of the (meth)acrylic resin particles is 60° C. or higher. This stabilizes the shape of the particles and allows the particles to have excellent long-term stability. The glass transition temperature of the (meth)acrylic resin particles can be measured with a differential scanning calorimeter (DSC).

When the (meth)acrylic resin particles have a carboxy group, the (meth)acrylic resin particles have increased water solubility and therefore have increased dispersion stability.

The average particle size of the (meth)acrylic resin particles is preferably 50 nm to 250 nm. When the average particle size of the (meth)acrylic resin particles is within the above range, an aqueous ink jet composition can be readily prepared and the dispersion stability of the particles in the aqueous ink jet composition and the storage stability of the aqueous ink jet composition are allowed to be more excellent. In the present specification, the term “average particle size” refers to the volume-based particle size distribution (50%) measured by a dynamic light scattering method.

### Nonionic Surfactant

The nonionic surfactant is not particularly limited. Specifically, examples of the nonionic surfactant include polyethylene glycol alkyl ethers such as polyethylene glycol cetyl ether, polyethylene glycol stearyl ether, polyethylene glycol oleyl ether, and polyethylene glycol behenyl ether; polyethylene glycol polypropylene glycol alkyl ethers such as polyethylene glycol polypropylene glycol cetyl ether and polyethylene glycol polypropylene glycol decyltetradecyl ether; polyethylene glycol alkylphenyl ethers such as polyethylene glycol octylphenyl ether and polyethylene glycol nonylphenyl ether; polyethylene glycol fatty acid esters such as ethylene glycol monostearate, ethylene glycol distearate, diethylene glycol stearate, polyethylene glycol distearate, polyethylene glycol monolaurate, polyethylene glycol monostearate, and polyethylene glycol monooleate; glycerin fatty acid esters such as glyceryl monomyristate, glyceryl monostearate, glyceryl monoisostearate, glyceryl distearate, and glyceryl dioleate; sorbitan fatty acid esters such as sorbitan monopalmitate, sorbitan monostearate, sorbitan tristearate, sorbitan monooleate, and sorbitan trioleate; polyethylene oxide adducts of glycerin fatty acid esters such as polyethylene oxide adducts of glyceryl monostearate and polyethylene oxide adducts of glyceryl monooleate; polyethylene oxide adducts of sorbitan fatty acid esters such as polyethylene oxide adducts of sorbitan monopalmitate, polyethylene oxide adducts of sorbitan monostearate, polyethylene oxide adducts of sorbitan tristearate, polyethylene oxide adducts of sorbitan monooleate, and polyethylene oxide adducts of sorbitan trioleate; polyethylene oxide adducts of sorbit fatty acid esters such as polyethylene oxide adducts of sorbit monolaurate, polyethylene oxide adducts of sorbit tetrastearate, polyethylene oxide adducts of sorbit hexastearate, and polyethylene oxide adducts of sorbit tetraoleate; and polyethylene oxide adducts of castor oil.

The above-cited nonionic surfactants may be used alone or in combination.

The content of the nonionic surfactant is preferably 2% by mass to 50% by mass, more preferably 5% by mass to 45% by mass, and further more preferably 10% by mass to 40% by mass with respect to the total mass of the (meth)acrylic resin particles. When the content of the nonionic surfactant is within the above range, coloring on a recording medium can be ensured and the storage stability of the colorant dispersion is allowed to be more excellent.

### Tertiary Amine Compound

The content of the tertiary amine compound is preferably 5% by mass to 50% by mass, more preferably 7% by mass to 45% by mass, and further more preferably 10% by mass to 40% by mass with respect to the total mass of the (meth)acrylic resin particles. When the content of the tertiary amine compound is within the above range, the amount of a colorant in the (meth)acrylic resin particles is small, the print density of an ink composition for aqueous ink jet recording is not reduced, and dispersing the colorant allows coloring properties to be excellent.

### Method for Preparing Colorant Dispersion

The colorant dispersion according to this embodiment can be prepared in such a manner that the above components are uniformly mixed, are heated, and are then subjected to a polymerization reaction using an initiator such that the (meth)acrylic resin particles are formed, followed by removing impurities, foreign substances, and the like by pH adjustment or filtration as required. As a method for inducing the polymerization reaction, the following method is used: a method in which water is added to a reaction vessel equipped with a stirring device such as a mechanical stirrer or a magnetic stirrer and a heating-cooling device, the above components are uniformly mixed using a stirring device such as a mechanical stirrer or a magnetic stirrer, and a mixed solution is added to the reaction vessel heated to an arbitrary reaction temperature together with an initiator and is subjected to reaction. Centrifugal filtration, filter filtration, and the like can be used as a filtration method.

### Ink Composition for Aqueous Ink Jet Recording

An ink composition for aqueous ink jet recording according to this embodiment contains the above-mentioned colorant dispersion and further contains a water-soluble organic solvent, various additives, and the like. Components contained in the ink composition for aqueous ink jet recording are described below. In descriptions below, the ink composition for aqueous ink jet recording is simply referred to as the ink composition in some cases.

### Colorant Dispersion

The content of the (meth)acrylic resin particles in the colorant dispersion is preferably 2% by mass to 30% by mass, more preferably 2% by mass to 25% by mass, and further more preferably 2% by mass to 20% by mass with respect to the total mass of the ink composition. When content of the (meth)acrylic resin particles is within the above range, coloring properties further improve and the dispersion stability of the particles in the ink composition for aqueous ink jet recording and the storage stability of the ink composition for aqueous ink jet recording are allowed to be more excellent.

### Water-Soluble Organic Solvent

The water-soluble organic solvent can be used in the ink composition for aqueous ink jet recording. Examples of the water-soluble organic solvent include polyalcohols such as glycerin, ethylene glycol, diethylene glycol, isopropylidene glycerol, 1,3-butanediol, 3-methyl-1,3-butanediol, triethylene glycol, propylene glycol, dipropylene glycol, trimethylol propane, trimethylol ethane, tripropylene glycol, tetraethylene glycol, hexylene glycol, polyethylene glycol, polypropylene glycol, 1,5-pentanediol, 1,6-hexane diol, 1,2,6-hexanetriol, 1,2,4-butanetriol, 1,2,3-butanetriol, and petriol; polyalcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, propylene glycol monoethyl ether, and triethylene glycol monobutyl ether; polyalcohol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylformamide, N,N-dimethylformamide, N,N-dimethyl-β-methoxypropionamide, and N,N-dimethyl-β-butoxypropionamide; amines such as monoethanolamine, diethanolamine, triethanolamine, monoethylamine, diethylamine, and triethylamine; and sulfur-containing compounds such as dimethyl sulfoxide, sulfolane, and thiodiethanol.

The water-soluble organic solvent may be used alone or in combination with one or more other water-soluble organic solvents.

The content of the water-soluble organic solvent is preferably 2% by mass to 60% by mass, more preferably 2% by mass to 50% by mass, and further more preferably 2% by mass to 40% by mass with respect to the total mass of the ink composition for aqueous ink jet recording. Adding a predetermined amount of the water-soluble organic solvent to the ink composition for aqueous ink jet recording as described above enables the wettability of a recording medium with the ink composition and the penetration rate of the ink composition to be adjusted.

### Surfactant

The ink composition for aqueous ink jet recording may further contain a surfactant that is a surface tension modifier. Examples of the surfactant include, but are not limited to, an acetylene glycol surfactant, a fluorinated surfactant, and a polysiloxane surfactant.

Among these, the polysiloxane surfactant is more preferable because the solubility of the polysiloxane surfactant in the ink composition for aqueous ink jet recording is high and therefore foreign substances are unlikely to occur.

The acetylene glycol surfactant is not particularly limited and is preferably one or more selected from, for example, 2,4,7,9-tetramethyl-5-decyne-4,7-diol, an alkylene oxide adduct of 2,4,7,9-tetramethyl-5-decyne-4,7-diol, 2,4-dimethyl-5-decyn-4-ol, and an alkylene oxide adduct of 2,4-dimethyl-5-decyn-4-ol. Examples of commercially available products of the acetylene glycol surfactant include, but are not limited to, an Olfine® 104 series, an E-series such as Olfine E1010 (trade name, produced by Air Products Japan K.K.), Surfynol® 465, and Surfynol 61 (trade name, produced by Nissin Chemical Industry Co., Ltd.). The acetylene glycol surfactant may be used alone or in combination with one or more other acetylene glycol surfactants.

Examples of the fluorinated surfactant include, but are not limited to, perfluoroalkylsulfonic acid salts, perfluoroalkylcarboxylic acid salts, perfluoroalkylsulfonic acid esters, perfluoroalkyl-ethylene oxide adducts, perfluoroalkyl betaines, and perfluoroalkylamine oxide compounds. Examples of commercially available products of the fluorinated surfactant include, but are not limited to, S-144, S-145 (trade name, produced by AGC Inc.), FC-170C, FC-430, Fluorad FC4430 (trade name, produced by Sumitomo 3M Limited), FSO, FSO-100, FSN, FSN-100, FS-300 (trade name, produced by DuPont Inc.), FT-250, and FT-251 (trade name, produced by Neos Corporation). The fluorinated surfactant may be used alone or in combination with one or more other fluorinated surfactants.

Examples of the polysiloxane surfactant include polysiloxane compounds and polyether-modified organosiloxanes. Examples of commercially available products of the polysiloxane surfactant include, but are not limited to, BYK®-306, BYK-307, BYK-333, BYK-341, BYK-345, BYK-346, BYK-347, BYK-348, BYK-349 (trade name, produced by BYK Chemie Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade name, produced by Shin-Etsu Chemical Co., Ltd.).

The content of the surfactant is preferably 0.2% by mass to 1.4% by mass, more preferably 0.4% by mass to 1.2% by mass, and further more preferably 0.6% by mass to 1.0% by mass with respect to the total mass of the ink composition for aqueous ink jet recording. When the content of the surfactant is within the above range, printing in which the bleeding of the ink composition for aqueous ink jet recording is little can be expected in permeable recording media by enhancing the wettability of a recording medium.

### Other Additives

The ink composition for aqueous ink jet recording may further contain a fungicide, a preservative, an oxidation inhibitor, an ultraviolet absorber, a chelating agent, an oxygen absorber, a pH adjustor (for example, diethanolamine, adipic acid, or potassium hydroxide), a dissolution aid, or various additives that can be used in usual ink composition for aqueous ink jet recording as required. The various additives may be used alone or in combination.

### Method for Preparing Ink Composition

The ink composition for aqueous ink jet recording according to this embodiment can be prepared in such a manner that the above-mentioned components are mixed in an arbitrary order and impurities, foreign substances, and the like are removed by filtration or the like as required. As a method for mixing the components, the following method is used: a method in which the components are sequentially added to a vessel equipped with a stirring device such as a mechanical stirrer or a magnetic stirrer, followed by stirring and mixing. Centrifugal filtration, filter filtration, and the like can be used as a filtration method.

According to this embodiment, effects below can be obtained. Using the nonionic surfactant and the tertiary amine compound allows the (meth)acrylic resin particles to contain a larger amount of the disperse dye. Therefore, preparing the ink composition for aqueous ink jet recording from the colorant dispersion and using the ink composition for aqueous ink jet recording for printing enable coloring properties of a recorded material to be enhanced. Since the glass transition temperature of the (meth)acrylic resin particles is 60° C. or higher, the ink composition for aqueous ink jet recording have excellent long-term stability. When the content of the disperse dye is 10% by mass or more, a recorded material obtained using the ink composition for aqueous ink jet recording has increased coloring properties.

The present disclosure is further described below in detail with reference to examples and comparative examples. The present disclosure is not limited to the examples.

### EXAMPLES

### Preparation of Colorant Dispersion

### Colorant Dispersion A

Ion-exchanged water (21.0 g) was charged into a reactor equipped with a stirring device, a reflux condenser, a thermometer, a nitrogen inlet tube, and three dropping funnels and was stirred with nitrogen fed thereto and the reactor was heated to 85° C. A homogenized solution made by mixing and stirring ion-exchanged water (18.0 g), methyl methacrylate (MMA, 30.0 g), C. I. Solvent Blue 5 (3.0 g), a polyoxyethylene alkylamine (1.2 g), a polyoxyethylene alkyl ether (0.6 g), and sodium dodecylbenzenesulfonate (2.1 g) and a solution made by dissolving ammonium persulfate (0.6 g) that was a polymerization initiator in ion-exchanged water (21.7 g) were charged into the reactor together over 1.5 hours. After all the solutions were charged and were aged for one hour, the reactor was cooled, ion-exchanged water was added, and the pH was adjusted to 7.5 with ammonia water. Coarse particles were removed by filtration using a membrane filter with a pore size of 1 μm and the average particle size of (meth)acrylic resin particles in obtained Colorant Dispersion A was measured using ELSA-1000 (manufactured by Otsuka Electronics Co., Ltd.) and was found to be about 260 nm. The glass transition temperature of the (meth)acrylic resin particles was measured using DSC 8000 (manufactured by Perkin Elmer Ltd.) and was found to be about 100° C.

Colorant Dispersions B to K were prepared in substantially the same manner as that used to prepare Colorant Dispersion A except that the type and additive amount of each material were varied with reference to Table 1. The average particle size and glass transition temperature of (meth)acrylic resin particles in each dispersion were listed in Table 1.

TABLE 1

| | | | Dispersion A | Dispersion B | Dispersion C | Dispersion D | Dispersion E | Dispersion F | Dispersion G |
|---|---|---|---|---|---|---|---|---|---|
| (Meth)acrylic | Disperse | SB5 | 10 | — | — | 10 | 10 | 10 | 10 |
| resin | dye | SY33 | — | 13 | — | — | — | — | — |
| particles | | SR111 | — | — | 15 | — | — | — | — |
| | Resin | MMA | 90 | 90 | 90 | 20 | — | 89 | 90 |
| | monomer | BzMA | — | — | — | 70 | 55 | — | — |
| | | BA | — | — | — | — | — | — | — |
| | | St | — | — | — | — | 35 | — | — |
| | | AA | — | — | — | — | — | 1 | — |

| | | | | | | | | |
|---|---|---|---|---|---|---|---|---|
| Anionic surfactant | DBS | 7 | 7 | 7 | 7 | 7 | 7 | 7 |
| Nonionic surfactant | PEOAE | 2 | 2 | 2 | 2 | 2 | 2 | 2 |
| Tertiary amine compound | PEOAM | 4 | 4 | 4 | 4 | 4 | 4 | 4 |

| | | | | | | | |
|---|---|---|---|---|---|---|---|
| Glass transition temperature of | 100 | 100 | 100 | 70 | 70 | 100 | 100 |
| resin particles [° C.] | | | | | | | |
| Average particle size of resin | 260 | 260 | 260 | 260 | 260 | 260 | 200 |
| particles [nm] | | | | | | | |

| | | | Dispersion H | Dispersion I | Dispersion J | Dispersion K | Dispersion L | Dispersion M | Dispersion N |
|---|---|---|---|---|---|---|---|---|---|
| (Meth)acrylic | Disperse | SB5 | 10 | 10 | 10 | 10 | 1 | 10 | 10 |
| resin | dye | SY33 | — | — | — | — | — | — | — |
| particles | | SR111 | — | — | — | — | — | — | — |
| | Resin | MMA | 90 | 90 | 90 | 90 | 90 | — | — |
| | monomer | BzMA | — | — | — | — | — | — | — |
| | | BA | — | — | — | — | — | 90 | — |
| | | St | — | — | — | — | — | — | 90 |
| | | AA | — | — | — | — | — | — | — |

| | | | | | | | | |
|---|---|---|---|---|---|---|---|---|
| Anionic surfactant | DBS | — | — | 9 | 7 | 7 | 7 | 7 |
| Nonionic surfactant | PEOAE | 10 | 10 | — | 2 | 2 | 2 | 2 |
| Tertiary amine compound | PEOAM | 4 | 10 | 4 | — | 4 | 4 | 4 |

| | | | | | | | |
|---|---|---|---|---|---|---|---|
| Glass transition temperature of | 100 | 100 | 100 | 100 | 100 | −55 | 100 |
| resin particles [° C.] | | | | | | | |
| Average particle size of resin | 200 | 200 | 260 | 260 | 260 | 260 | 260 |
| particles [nm] | | | | | | | |

The additive amount is shown in mass percent. All are shown for the concentration of solid matter.

Full names of abbreviations used in Table 1 are as described below.

SB5: Solvent Blue 5

SY33: Solvent Yellow 33

SR111: Solvent Red 111

MMA: Methyl methacrylate

BzMA: Benzyl methacrylate

BA: Butyl acrylate

St: Styrene

AA: Acrylic acid

DBS: Sodium dodecylbenzenesulfonate

PEOAE: Polyoxyethylene alkyl ether

PEOAM: Polyoxyethylene alkylamine

### Preparation of Ink Composition for Aqueous Ink Jet Recording

### Example 1

Ink compositions of Examples 1 to 9 and Comparative Examples 1 to 5 were prepared based on the compositions shown in Table 2.

TABLE 2

| | | Example 1 | Example 2 | Example 3 | Example 4 | Example 5 | Example 6 | Example 7 | Example 8 |
|---|---|---|---|---|---|---|---|---|---|
| Colorant dispersion | | A | B | C | D | E | F | G | H |
| | | 8.00 | 8.00 | 8.00 | 8.00 | 8.00 | 8.00 | 8.00 | 8.00 |
| Aqueous | Glycerin | 15.00 | 15.00 | 15.00 | 15.00 | 15.00 | 15.00 | 15.00 | 15.00 |
| organic | DEGmBE | 3.00 | 3.00 | 3.00 | 3.00 | 3.00 | 3.00 | 3.00 | 3.00 |
| solvent | TMP | 5.00 | 5.00 | 5.00 | 5.00 | 5.00 | 5.00 | 5.00 | 5.00 |
| Surfactant | Olfine E1010 | 0.50 | 0.50 | 0.50 | 0.50 | 0.50 | 0.50 | 0.50 | 0.50 |
| pH adjustor | Potassium | 0.10 | 0.10 | 0.10 | 0.10 | 0.10 | 0.10 | 0.10 | 0.10 |
| | hydroxide | | | | | | | | |
| Preservative | Proxel XL-2 | 0.05 | 0.05 | 0.05 | 0.05 | 0.05 | 0.05 | 0.05 | 0.05 |
| Water | Ion-exchanged | Balance | Balance | Balance | Balance | Balance | Balance | Balance | Balance |
| | water | | | | | | | | |

| | | | | | | | | |
|---|---|---|---|---|---|---|---|---|
| Total | 100.00 | 100.00 | 100.00 | 100.00 | 100.00 | 100.00 | 100.00 | 100.00 |

| | | | Comparative | Comparative | Comparative | Comparative | Comparative |
|---|---|---|---|---|---|---|---|
| | | Example 9 | Example 1 | Example 2 | Example 3 | Example 4 | Example 5 |
| Colorant dispersion | | I | J | K | L | M | N |
| | | 8.00 | 8.00 | 8.00 | 8.00 | 8.00 | 8.00 |
| Aqueous | Glycerin | 15.00 | 15.00 | 15.00 | 15.00 | 15.00 | 15.00 |
| organic | DEGmBE | 3.00 | 3.00 | 3.00 | 3.00 | 3.00 | 3.00 |
| solvent | TMP | 5.00 | 5.00 | 5.00 | 5.00 | 5.00 | 5.00 |
| Surfactant | Olfine E1010 | 0.50 | 0.50 | 0.50 | 0.50 | 0.50 | 0.50 |
| pH adjustor | Potassium | 0.10 | 0.10 | 0.10 | 0.10 | 0.10 | 0.10 |
| | hydroxide | | | | | | |
| Preservative | Proxel XL-2 | 0.05 | 0.05 | 0.05 | 0.05 | 0.05 | 0.05 |
| Water | Ion-exchanged | Balance | Balance | Balance | Balance | Balance | Balance |
| | water | | | | | | |

| | | | | | | |
|---|---|---|---|---|---|---|
| Total | 100.00 | 100.00 | 100.00 | 100.00 | 100.00 | 100.00 |

The additive amount is shown in mass percent. All are shown for the concentration of solid matter.

Full names of abbreviations used in Table 2 are as described below.

DEGmBE: Diethylene glycol monobutyl ether

TMP: Trimethylolpropane

### Evaluation Method

Evaluation was performed in accordance with evaluation criteria below.

### Coloring Properties (Optical Density)

The optical density of a print made with an ink jet printer was measured as an indicator for coloring properties. The ink composition of each of the examples and the comparative examples was applied to MCPW paper (produced by Toppan Forms Co., Ltd.) using an ink jet printer, M105, (manufactured by Seiko Epson Corporation) in a plain paper standard mode and the OD (optical density) value measured using a colorimeter (Gretag Macbeth Spectrolino, manufactured by X-Rite Inc.) was evaluated in accordance with evaluation criteria below.

AA: 1.3≤OD

A: 1.1≤OD<1.3

B: 0.9≤OD<1.1

C: OD<0.9

### Storage Stability

A precipitate of an ink composition was measured as an indicator for storage stability. Each of the ink compositions of the examples and the comparative examples was put in a 30 ml glass vial. After the glass vial was sealed, the glass vial was left to stand at 60° C. for five days. Thereafter, visual evaluation was performed in accordance with evaluation criteria below.

A: No precipitate is observed.

B: A slight amount of precipitate is observed.

C: A large amount of precipitate is observed.

D: Most precipitates/coagulates (aggregates).

TABLE 3

| | Example 1 | Example 2 | Example 3 | Example 4 | Example 5 | Example 6 | Example 7 | Example 8 |
|---|---|---|---|---|---|---|---|---|
| Coloring properties | B | B | B | B | B | B | B | A |
| Storage stability | B | B | B | B | B | A | A | A |

| | | Comparative | Comparative | Comparative | Comparative | Comparative |
|---|---|---|---|---|---|---|
| | Example 9 | Example 1 | Example 2 | Example 3 | Example 4 | Example 5 |
| Coloring properties | AA | C | C | C | C | C |
| Storage stability | A | C | D | B | D | B |

As shown in Table 3, Example 1 provided a result in which coloring properties of a print and storage stability were balanced, which was difficult for colored particles in the related art. Examples 2 and 3 in which a disperse dye was changed provided a result similar to that of Example 1. Examples 4 and 5 in which a monomer forming (meth)acrylic resin particles was changed provided a result similar to that of Example 1. Example 6 in which a carboxy group was introduced and Example 7 in which the average particle size was 50 nm to 250 nm provided increased storage stability as compared to Example 1. Example 8 was such that the content of a nonionic surfactant of Example 7 was 2% by mass to 50% by mass with respect to the total mass of the (meth)acrylic resin particles and therefore coloring properties of a print further increased. Example 9 was such that the content of a tertiary amine compound of Example 8 was 5% by mass to 50% by mass with respect to the total mass of (meth)acrylic resin particles and therefore coloring properties of a print further increased.

Comparative Example 1 was such that no nonionic surfactant was contained and therefore coloring properties of a print decreased. Comparative Example 2 was such that no tertiary amine compound was contained and therefore coloring properties of a print were significantly low. Comparative Example 3 was such that the content of a disperse dye was outside the above range and therefore coloring properties of a print were significantly low. Comparative Example 4 was such that the glass transition temperature was lower than 60° C., coloring properties of a print decreased, and storage stability decreased significantly. Comparative Example 5 was such that a resin component was not derived from any monomer derived from (meth)acrylic acid or a (meth)acrylic acid ester and therefore coloring properties of a print decreased slightly.

As described above, according to the examples of this embodiment, an ink composition for aqueous ink jet recording excellent in storage stability and coloring properties of a recorded material can be provided.

What is claimed is:

1. A colorant dispersion comprising:
water;
(meth)acrylic resin particles containing a disperse dye;
a nonionic surfactant; and
a tertiary amine compound represented by the following formula (1): 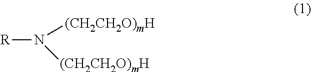
where R represents —(CH₂CH₂O)ₘH, an aliphatic group containing 6 to 18 carbon atoms, or an aromatic group and each m independently represents an integer of 1 to 10, wherein
the (meth)acrylic resin particles have a glass transition temperature of 60° C. or higher and contain 10% by mass or more of the disperse dye with respect to a total mass of the (meth)acrylic resin particles.

2. The colorant dispersion according to claim 1, wherein the (meth)acrylic resin particles have a carboxy group.

3. The colorant dispersion according to claim 1, wherein an average particle size of the (meth)acrylic resin particles is 50 nm to 250 nm.

4. The colorant dispersion according to claim 1, wherein a content of the nonionic surfactant is 2% by mass to 50% by mass with respect to the total mass of the (meth)acrylic resin particles.

5. The colorant dispersion according to claim 1, wherein a content of the tertiary amine compound is 5% by mass to 50% by mass with respect to the total mass of the (meth)acrylic resin particles.

6. The colorant dispersion according to claim 1, wherein the (meth)acrylic resin particles contain a resin component derived from one or more monomers derived from (meth)acrylic acid or a (meth)acrylic acid ester.

7. An ink composition for aqueous ink jet recording, comprising:
water;
(meth)acrylic resin particles containing a disperse dye;
a nonionic surfactant; and
a tertiary amine compound represented by the following formula (1): 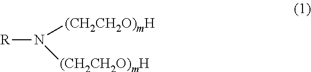
where R represents —(CH₂CH₂O)ₘH, an aliphatic group containing 6 to 18 carbon atoms, or an aromatic group and each m independently represents an integer of 1 to 10, wherein
the (meth)acrylic resin particles have a glass transition temperature of 60° C. or higher and contain 5% by mass or more of the disperse dye with respect to a total mass of the (meth)acrylic resin particles.
